(19) United States
(12) Patent Application Publication
(10) Pub. No.: US 2013/0162091 A1
(43) Pub. Date: Jun. 27, 2013

(54) ROTATIONAL ELECTRIC MOTOR AND ROTOR THEREOF HAVING STRUCTURE FOR PREVENTING LAMINATED CORE FROM BEING DAMAGED

(71) Applicant: FANUC CORPORATION, Minamitsuru-gun (JP)

(72) Inventor: Yohei ARIMATSU, Minamitsuru-gun (JP)

(73) Assignee: FANUC CORPORATION, Minamitsuru-gun (JP)

(21) Appl. No.: 13/717,875

(22) Filed: Dec. 18, 2012

(30) Foreign Application Priority Data
Dec. 22, 2011 (JP) 2011-281652

(51) Int. Cl. H02K 1/27

(52) U.S. Cl. CPC H02K 1/274
USPC 310/156.53

(57) ABSTRACT

A rotor of a rotational electric motor including a core formed from laminated magnetic steel sheets, and a plurality of magnet arrays extending in a laminating direction of the core is provided. Magnets forming each of the plurality of magnet arrays are selected from first magnets and second magnets. A ratio of the length of the first magnet to that of the second magnet is one to two. The magnet arrays are arranged such that they include at least two of the second magnets and boundary planes between the magnets are offset relative to each other so as not to coincide with each other in a direction perpendicular to the laminating direction.

### BACKGROUND OF THE INVENTION

1. Field of the Invention

The present invention relates to a rotor of a rotational electric motor, and in particular, to a rotor of a rotational electric motor including a core formed from laminated magnetic steel sheets, and magnets. The present invention also relates to a rotational electric motor including such a rotor.

2. Description of Related Art

FIG. 12 is a perspective view showing a rotor 100 of a rotational electric motor according to a prior art with the rotor 100 cut in half so as to have a half cylinder shape. FIG. 13 is a schematic view showing magnet arrays 102 of the rotor 100 of the rotational electric motor of FIG. 12, in a developed plan view. The rotor 100 includes a core 104 formed from laminated magnetic steel sheets in a laminating direction D, and a plurality of magnet arrays 102 embedded inside the core 104 along a circumferential direction of the core 104. Each magnet array 102 includes a plurality of magnets 106 arranged side by side in the laminating direction D of the core 104. The magnets 106 used for forming the magnet array 102 generally have an identical shape to one another in order to reduce procurement cost and management cost for the magnets 106. Therefore, as illustrated, boundary planes between the magnets 106 in each magnet array 102 is arranged in an alignment relative to other magnet arrays 102 adjacent thereto in the circumferential direction of the core 104. However, in the case where these boundary planes of the magnets 106 are locally close to one another, due to repulsive force acting between the magnets 106, a crack or a gap may be formed along an adhered surface or a caulked portion of the magnetic steel plate of the core 104, which may result in separation of the core 104 and in damaging the rotor 100.

On the other hand, JP-A-2000-134836 discloses a rotor in which each magnet array includes a plurality of magnets having lengths different from one another such that the boundary planes between the magnets are offset relative to one another. FIG. 14 is a schematic view showing magnet arrays 110 of a rotor of a rotational electric motor according to a comparative example, in a developed plan view. The comparative example shown in FIG. 14 is directed to the arrays 110 which are elongated in a laminating direction of the core (not shown) by expanding the technical concept taught by JP-A-2000-134836. As illustrated, boundary planes between magnets in this comparative example are not aligned to one another in a rotational direction of the rotor. Accordingly, the core can be prevented from being damaged.

However, since a number of different kinds of magnets having different lengths from one another in the laminating direction are used in this comparative example, care in determining an appropriate arrangement of magnets is required, and procurement cost and management cost is thereby increased.

Thus, there is a need for a rotor of a rotational electric motor having a structure for preventing a laminated core from being damaged, and for a rotational electric motor including such a rotor.

### SUMMARY OF THE INVENTION

In accordance with a first invention of the present application, a rotor of a rotational electric motor including a core formed from laminated magnetic steel sheets, and a plurality of magnet arrays attached to the core and extending in a laminating direction of the core, wherein each of the plurality of magnet arrays includes a plurality of magnets arranged side by side in the laminating direction, the magnets including at least one of two kinds of magnets including a first magnet and a second magnet, a ratio of length of the first magnet to length of the second magnet in the laminating direction being one to two, at least two of the plurality of magnet arrays including at least two of the second magnets, and wherein boundary planes between the magnets of each of the plurality of magnet arrays are offset relative to each other so as not to coincide with each other across a cross section of the core perpendicular to the laminating direction is provided.

In accordance with a second invention according to the present application, the rotor of a rotational electric motor according to the first invention, wherein the number of the first magnets used to form the plurality of magnet arrays is the same as the number of the magnet arrays is provided.

In accordance with a third invention according to the present application, the rotor of a rotational electric motor according to the first or the second invention, wherein the core is configured in a laminating manner such that the length of the core in the laminating direction is an integer multiple of the length of the first magnet in the laminating direction and four times or more longer than the length of the first magnet in the laminating direction is provided.

In accordance with a fourth invention according to the present application, a rotational electric motor including the rotor according to any one of the first to the third inventions is provided.

These and other objects, features and advantages of the present invention will be more apparent in light of the detailed description of exemplary embodiment thereof as illustrated by the drawings.

### BRIEF DESCRIPTION OF THE DRAWINGS

FIG. 1 is a perspective view showing a rotor of a rotational electric motor according to an embodiment of the present invention, with the rotor cut in half so as to have a half cylinder shape;

FIG. 2 is a sectional view showing the rotor of a rotational electric motor of FIG. 1;

FIG. 3 is a schematic view showing the magnet arrays of the rotor of FIG. 1, in a developed plan view;

FIG. 4 is a schematic view showing magnet arrays of a rotor of a rotational electric motor according to another embodiment of the present invention, in a developed plan view;

FIG. 5 is a schematic view showing magnet arrays of a rotor of a rotational electric motor according to another embodiment of the present invention, in a developed plan view;

FIG. 6 is a schematic view showing magnet arrays of a rotor of a rotational electric motor according to another embodiment of the present invention, in a developed plan view;

FIG. 7 is a schematic view showing magnet arrays of a rotor of a rotational electric motor according to another embodiment of the present invention, in a developed plan view;

FIG. 8 is a schematic view showing magnet arrays of a rotor of a rotational electric motor according to another embodiment of the present invention, in a developed plan view;

FIG. 9 is a sectional view showing a rotor of a rotational electric motor according to another embodiment of the present invention;

FIG. 10 is a schematic view showing magnet arrays of the rotor of FIG. 9, in a developed plan view;

FIG. 11 is a schematic view showing magnet arrays of a rotor of a rotational electric motor according to another embodiment of the present invention, in a developed plan view;

FIG. 12 is a perspective view showing a rotor of a rotational electric motor according to a prior art, with the rotor cut in half so as to have a half cylinder shape;

FIG. 13 is a schematic view showing magnet arrays of the rotor of a rotational electric motor of FIG. 12, in a developed plan view; and

FIG. 14 is a schematic view showing magnet arrays of a rotor of a rotational electric motor according to a comparative example, in a developed plan view.

### DETAILED DESCRIPTION

Embodiments of the present invention will be described below with reference to the accompanying drawings. For easy understanding, the size of one element in relation to another in illustrated embodiments may differ from that in practical application.

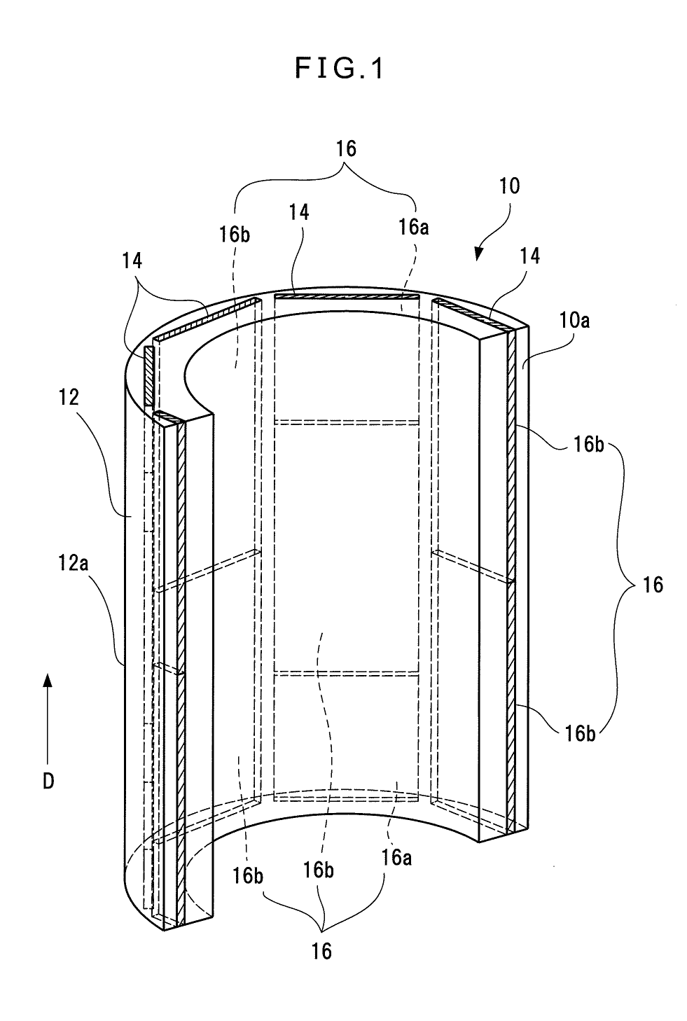

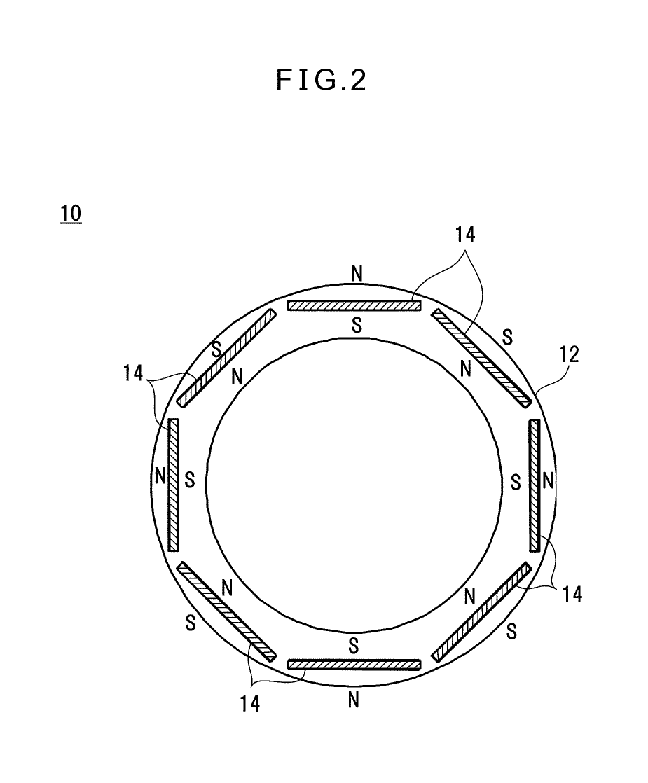

FIG. 1 is a perspective view showing a rotor 10 of a rotational electric motor according to an embodiment of the present invention, with the rotor 10 cut in half so as to have a half cylinder shape. FIG. 2 is a sectional view showing the rotor 10 of a rotational electric motor of FIG. 1. In FIG. 1, for easy understanding, only one of the half cylinders 10a is shown. The half cylinder 10a as illustrated and the other half cylinder integrally form the rotor 10 having a cylindrical shape. The rotor 10 includes a core 12 formed from laminated magnetic steel sheets and a plurality of magnet arrays 14 attached to the core 12 and extending in a laminating direction D of the core 12. The laminating direction D extends in parallel to a rotational axis of the rotor 10. The core 12 is formed by superimposing thin magnetic steel sheets in the laminating direction and adhering or caulking them together. The core 12 has a cylindrical outer shape.

The magnet arrays 14 are embedded inside the core 12 so as to be accommodated in slots formed in the core 12. The magnet array 14 may be provided in a known manner such as by adhering magnets 16, which will be described below, in the slots, or by filling a gap between the magnets 16 and the slots with resin. As can be seen more clearly in FIG. 2, the magnet arrays 14 are arranged generally at equal intervals in a circumferential direction of the core 12. The magnet arrays 14 may be attached to an outer circumferential surface 12a of the core 12 by means of adhesive. Further, a reinforcing structure for externally reinforcing fixation between the core 12 and the magnet arrays 14 may be provided. The reinforcing structure may be, for example, a tubular body made of a metal, CFRP (carbon fiber reinforced plastic) or GFRP (glass fiber reinforced plastic) which covers the magnet arrays 14 from the outside and presses the magnet arrays 14 onto the core 12 so as to provide a fixing effect thereto. Such a reinforcing structure is effective in improving reliability of the rotor 10, particularly in applications in which rotational speed of the rotor 10 is increased.

Each magnet array 14 is formed from a plurality of magnets 16 arranged side by side in the laminating direction D of the core 12. In the present embodiment, first magnets 16a and second magnets 16b are used as the magnets 16 to form the magnet array 14. The first magnets 16a have a length L in the laminating direction D. The second magnets 16b have a length 2L, which is twice the length L of the first magnets 16a in the laminating direction D. Thus, the ratio of the length of the first magnet 16a to that of the second magnet 16b in the laminating direction D is one to two. For example, the first magnet 16a may be 50 mm in the laminating direction D, while the second magnet 16b may be 100 mm in the laminating direction D. Each magnet array 14 is formed by arranging side by side a plurality of at least one of the two kinds of magnets, which are the first magnet 16a and the second magnet 16b. Each magnet array 14 is substantially the same size as the core 12 in the laminating direction D.

The magnets 16 of the magnet array 14 are magnetized in the same direction in a radial direction of the core 12, so as to form one pole together. That is, each magnet array 14 forms one pole extending over the entire length thereof in the laminating direction D. As illustrated in FIG. 2, the magnetizing direction of each magnet array 14 is opposite to that of adjacent magnet arrays 14. Specifically, if one magnet array 14 has N. pole on the outer side of the core 12 in the radial direction and has S. pole on the inner side of the core 12, each of magnet arrays 14 arranged adjacent thereto on both sides has S. pole on the outer side of the core 12 in the radial direction and has N. pole on the inner side of the core 12. Although not illustrated in the drawings, a stator of the rotational electric motor is arranged on the outside of the rotor 10 in the radial direction, so as to enclose the rotor 10. The stator has electromagnets arranged so as to be opposed to each magnet array 14 of the rotor 10, so that repulsive force and attractive force are generated between the magnet arrays 14 of the rotor 10 and the electromagnets of the stator in order to rotate the rotor.

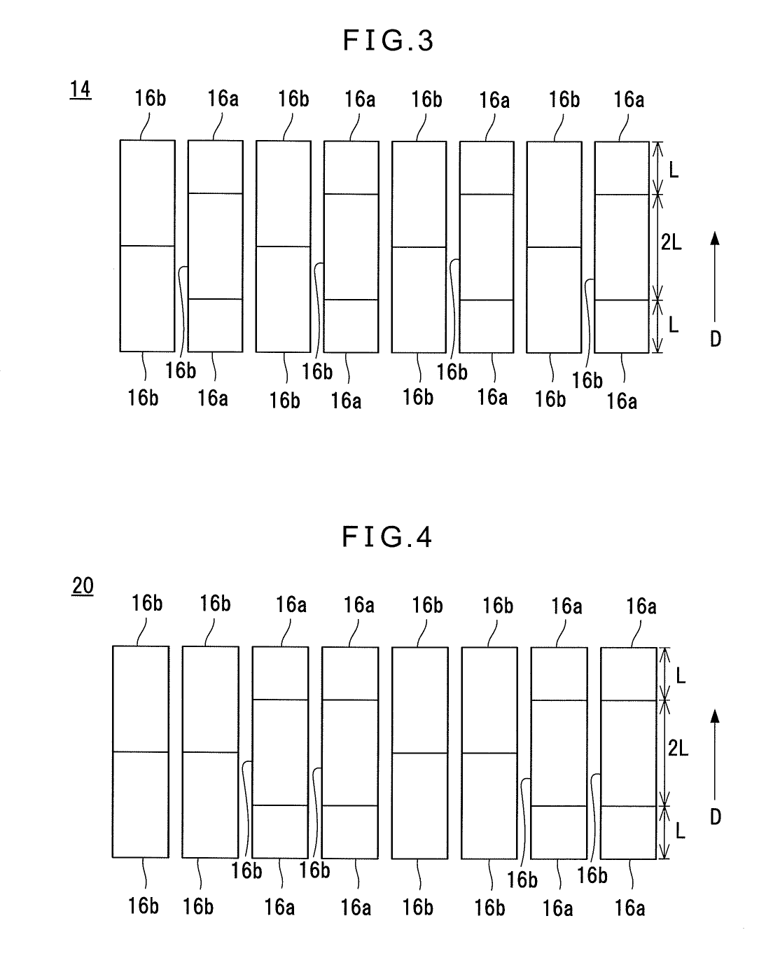

Next, referring to FIG. 3, how the magnets 16 are arranged will be described. FIG. 3 is a schematic view showing the magnet array 14 of the rotor 10 of FIG. 1, in a developed plan view. As described above, the magnets 16 include the first magnets 16a and the second magnets 16b. In the illustrated example, the length of each magnet array 14 in the laminating direction D, i.e., the length of the core 12 in the laminating direction D, is four times as long as the length L of the first magnet 16a in the laminating direction D. In the illustrated embodiment, the magnet arrays 14 are arranged alternately in a first sequential pattern and in a second sequential pattern. The first sequential pattern is formed from two second magnets 16b arranged side by side in the laminating direction D. The second sequential pattern is formed from two first magnets 16a and one second magnet 16b interposed between the first magnets 16a.

As illustrated, each magnet array 14 is arranged in relation to other magnet arrays 14 such that the boundary planes between the magnets 16 are offset relative to one another so as not to coincide in a direction orthogonal to the laminating direction D (rotational direction of the rotor 10). By arranging the boundary planes of the magnets 16 so as to be offset relative to one another, a magnetic action can be prevented from occurring in a locally concentrated manner. Thus, force exerted to the core 12 due to the magnetic action of the magnet arrays 14 can be distributed over the core 12, and a crack or a gap can be prevented from forming in the core 12 having a laminated structure. In addition, in accordance with the present invention, only two kinds of magnets 16, i.e., the first magnets 16a and the second magnets 16b, are used, so that procurement cost and management cost associated with the magnets 16 can be reduced. Further, in order to form the magnet arrays 14, the number of the first magnets 16a used in the illustrated embodiment is eight, which is the same as the number of the magnet arrays 14. Accordingly, the number of the first magnets 16a having the smaller size is restricted to use in the present embodiment, while the second magnets 16b having the larger size can be prioritized in use. Generally speaking, the lower the number of magnets required, the higher productivity in attaching the magnets to the core is improved. Therefore, in accordance with the present embodiment, manufacturing cost can be reduced and an inexpensive rotor 10 can be provided.

Referring to FIG. 4, another embodiment of the present invention will now be described. In the respective embodiments and variants thereof described below, the same or corresponding elements as those described in the above-described embodiment are designated with the same referential numerals, and explanation thereon is omitted.

FIG. 4 is a schematic view showing magnet arrays 20 of a rotor of a rotational electric motor according to another embodiment of the present invention, in a developed plan view. In this embodiment, a pair of adjoining magnet arrays 20 are arranged based on the same sequential pattern, and another pair of adjoining magnet arrays 20 adjacent thereto are arranged based on a sequential pattern different therefrom. Accordingly, if a pair of magnet arrays 20 is arranged based on the above-described first sequential pattern, each of the adjacent pairs of magnet arrays 20 on both sides is arranged based on the above-described second sequential pattern.

In this embodiment, the boundary planes between the magnets 16 of each magnet array 20 are offset relative to one another so as not to coincide with one other in the rotational direction of the rotor orthogonal to the laminating direction D. The number of the magnets 16a having the smaller size is the same as the number of the magnet arrays 20. Thus, in this embodiment, a rotational electric motor and a rotor used therefor with the advantages as described in relation to the above embodiment can be provided.

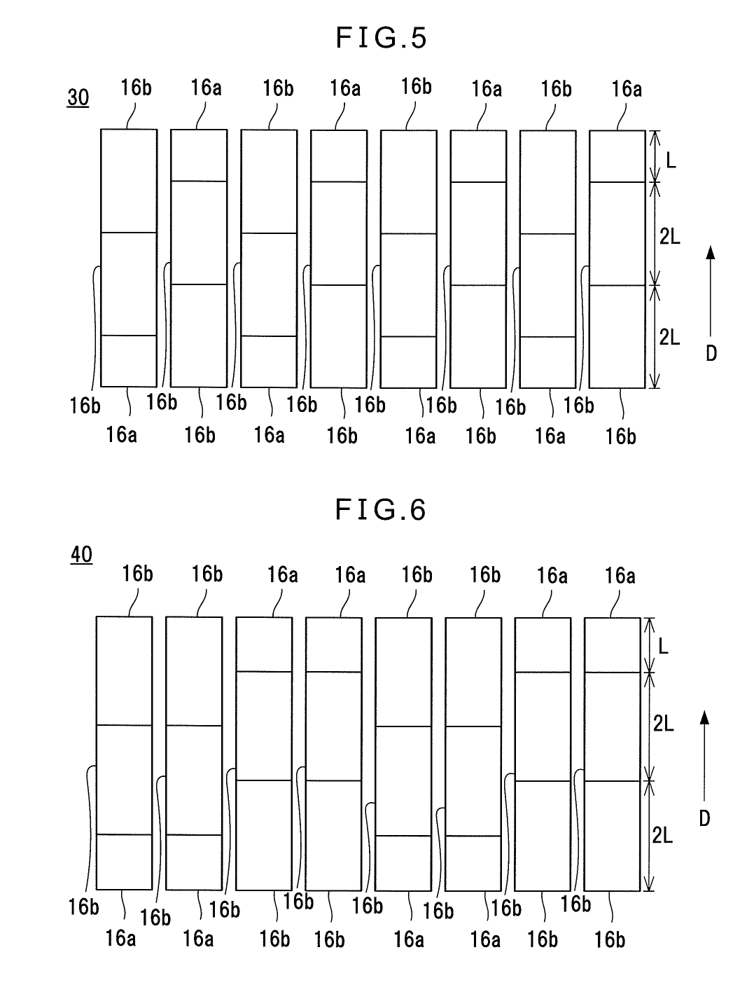

FIG. 5 is a schematic view showing magnet arrays 30 of a rotor of a rotational electric motor according to another embodiment of the present invention, in a developed plan view. In this embodiment, the length of each magnet array 30 in the laminating direction, i.e., the length of the core (not shown) in the laminating direction, is five times more than the length L of the first magnet 16a. Each magnet array 30 is arranged alternately in a third sequential pattern and in a fourth sequential pattern, as illustrated. The third sequential pattern is a combined pattern of two second magnets 16b arranged side by side in the laminating direction D and of one first magnet 16a arranged on the proximal end side of the laminating direction D. The fourth sequential pattern is a combined pattern of two second magnets 16b arranged side by side in the laminating direction D and of one first magnet 16a arranged on the distal end side of the laminating direction D and is formed from the third sequential pattern flipped over 180 degrees. In this embodiment, the boundary planes between the magnets 16 of each magnet array 30 are offset relative to one another so as to not to coincide with one another in the rotational direction of the rotor orthogonal to the laminating direction D. The number of the magnets 16a having the smaller size in use is the same as the number of the magnet arrays 30. Accordingly, also in accordance with this embodiment, a rotational electric motor and a rotor used therefor with the advantages as described in relation to the above embodiment can be provided.

FIG. 6 is a schematic view showing magnet arrays 40 of a rotor of a rotational electric motor according to another embodiment of the present invention, in a developed plan view. In this embodiment, a pair of adjoining magnet arrays 40 are arranged based on the same sequential pattern, and another pair of magnet arrays 40 adjacent thereto are arranged based on a sequential pattern different therefrom. Accordingly, for example, if a pair of magnet arrays 40 is arranged based on the above-described third sequential pattern, each pair of magnet arrays 40 adjacent thereto on both sides is arranged based on the fourth sequential pattern.

In this embodiment, the boundary planes between the magnets 16 of each magnet array 40 are offset relative to one another so as not to coincide with one another in the rotational direction of the rotor orthogonal to the laminating direction D. The number of the first magnet 16a having the smaller size in use is the same as the number of the magnet arrays 40. Accordingly, in accordance with this embodiment, a rotational electric motor and a rotor used therefor with the advantages as described in relation to the above embodiment can be provided.

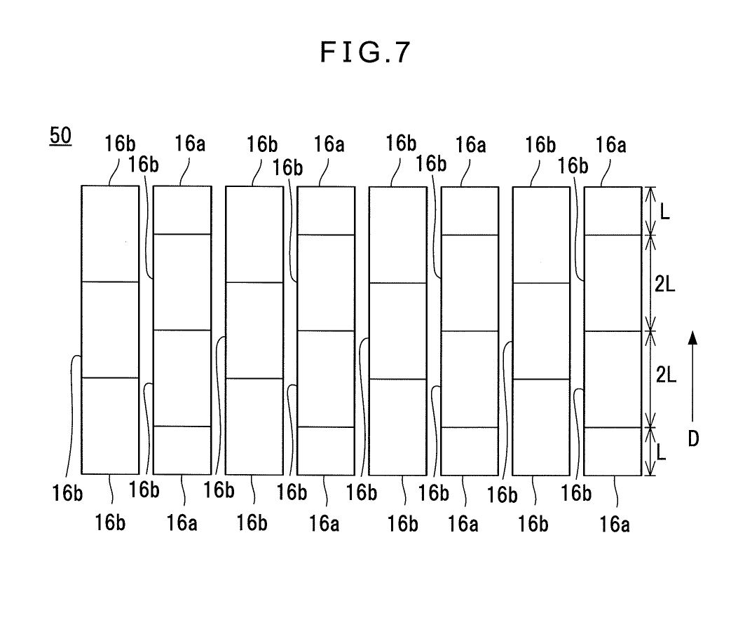

FIG. 7 is a schematic view showing magnet arrays 50 of a rotor of a rotational electric motor according to another embodiment of the present invention, in a developed plan view. In this embodiment, the length of each magnet array 50 in the laminating direction D, i.e., the length of the core (not shown) in the laminating direction D, is six times more than the length L of the first magnet 16a. As illustrated, each magnet array 50 is arranged alternately in a fifth sequential pattern and in a sixth sequential pattern. The fifth sequential pattern includes three second magnet 16b arranged side by side in the laminating direction D. The sixth sequential pattern includes two second magnets 16b arranged side by side in the laminating direction D and two first magnet 16a arranged so as to be sandwiched on both sides between the two second magnets 16b in the laminating direction D. In this embodiment, the boundary planes between the magnets 16 of each magnet array 50 are offset relative to one another so as not to coincide with one another in the rotational direction of the rotor orthogonal to the laminating direction D. The number of the first magnet 16a having the smaller size in use is the same as the number of the magnet arrays 50. Therefore, in accordance with this embodiment, a rotational electric motor and a rotor used therefor with the advantages as described in relation to the above embodiment can be provided.

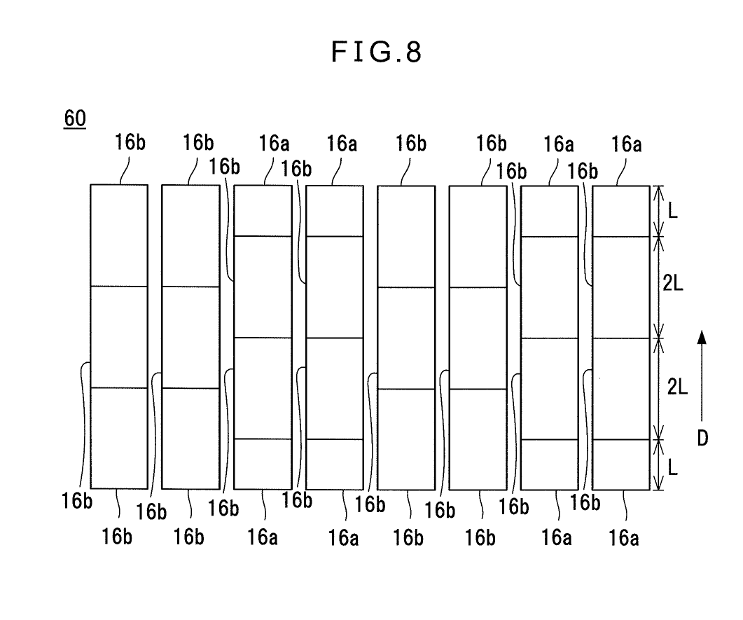

FIG. 8 is a schematic view showing magnet arrays 60 of a rotor of a rotational electric motor according to another embodiment of the present invention, in a developed plan view. In this embodiment, a pair of adjoining magnet arrays 60 are arranged based on the same sequential pattern, and another pair of magnet arrays 60 adjacent thereto are arranged based on a sequential pattern different therefrom. Accordingly, for example, if a pair of magnet arrays 60 are arranged based on the above-described fifth sequential pattern, each pair of magnet arrays 60 arranged adjacent thereto on both sides are arranged based on the sixth sequential pattern.

In this embodiment, the boundary planes between the magnets 16 of each magnet array 60 are offset relative to one another so as not to coincide with one another in the rotational direction of the rotor orthogonal to the laminating direction D. The number of the first magnet 16a having the smaller size in use is the same as the number of the magnet arrays 60. Therefore, in accordance with this embodiment, a rotational electric motor and a rotor used therefor with the advantages as described in relation to the above embodiment can be provided.

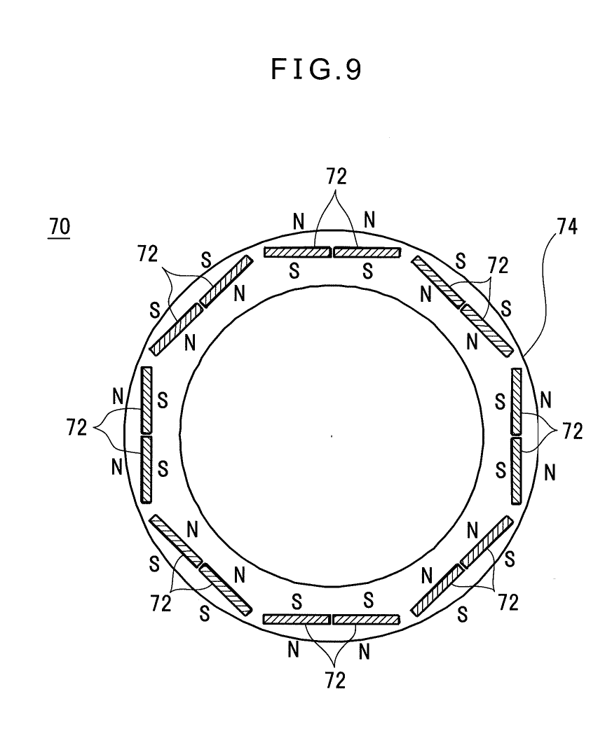

FIG. 9 is a sectional view showing a rotor 70 of a rotational electric motor according to another embodiment of the present invention. In the rotor 70 according to this embodiment, a plurality of magnet arrays form one pole. More specifically, a pair of magnet arrays 72 are magnetized in the same direction, as illustrated. Two magnet arrays 72 of another pair of magnet arrays 72 adjacent to these magnet arrays 72 in a circumferential direction of the core 74 are magnetized in an opposite direction. Therefore, the magnetizing directions are oriented alternately such that the adjacent poles are magnetized in opposite directions relative to each other. Accordingly, relatively greater magnetic force can be obtained in this embodiment, so that it is suitable for an application which involves rotation at high speed. In order to be able to endure greater centrifugal force when rotated at high speed, the rotor has a part of the core 74 extending between a pair of magnet arrays 72 forming one pole so as to separate the magnet arrays from each other.

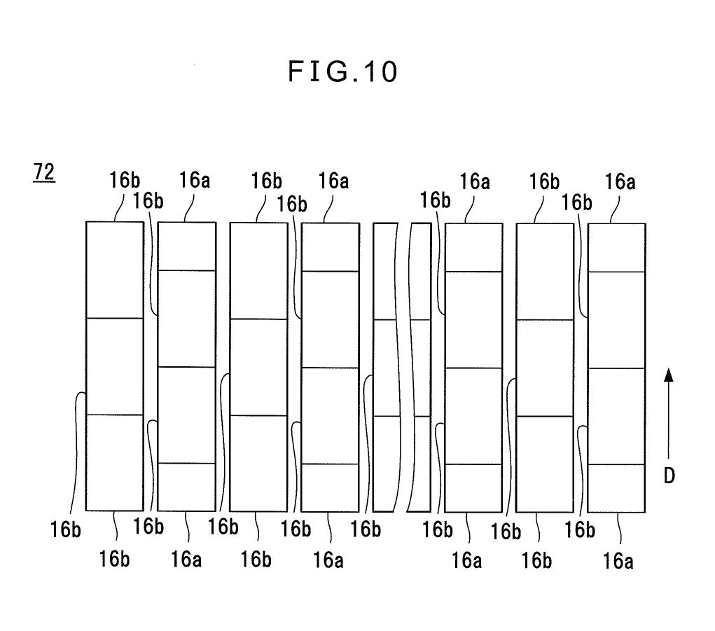

FIG. 10 is a schematic view showing magnet arrays 72 of the rotor of FIG. 9, in a developed plan view. In this embodiment, the length of each magnet array 72 in the laminating direction D, i.e., the length of the core (not shown) in the laminating direction D, is six times as long as the length of the first magnet 16a. As illustrated, each magnet array 72 is arranged alternately in the above-described fifth sequential pattern and in the above-described sixth sequential pattern. In the present embodiment, although sixteen magnet arrays 72 are actually provided in total, the magnet arrays 72 situated in the intermediate portion are omitted for the sake of clarification of the drawing, as shown in FIG. 9. Also in this embodiment, the boundary planes between the magnets 16 of each magnet array 72 are offset relative to one another so as not to coincide with one another in the rotational direction of the rotor 70 orthogonal to the laminating direction D. The number of the first magnet 16a having the smaller size in use is the same as the number of the magnet arrays 72. Therefore, also in this embodiment, a rotational electric motor and a rotor used therefor with the advantages as described above in relation to the above embodiment can be provided.

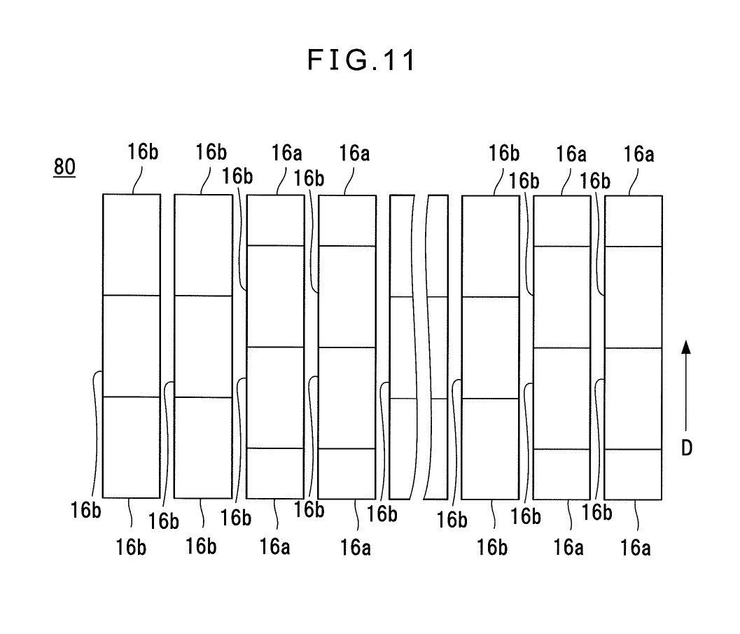

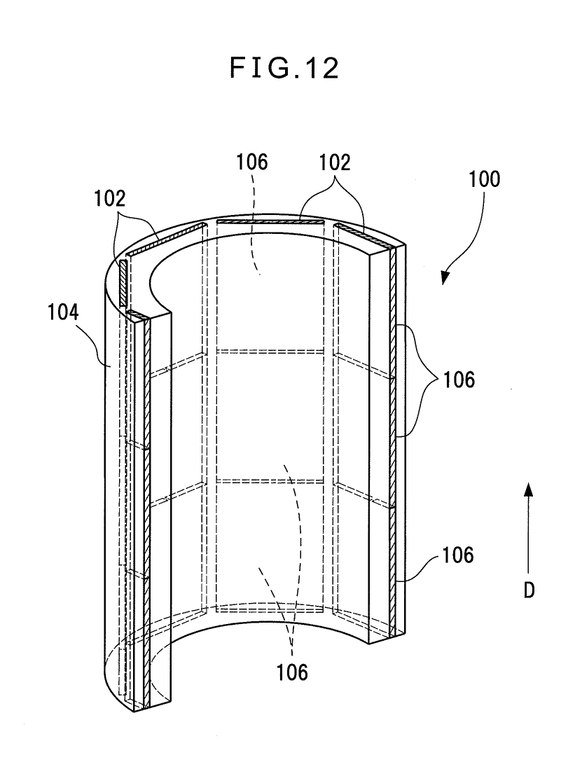

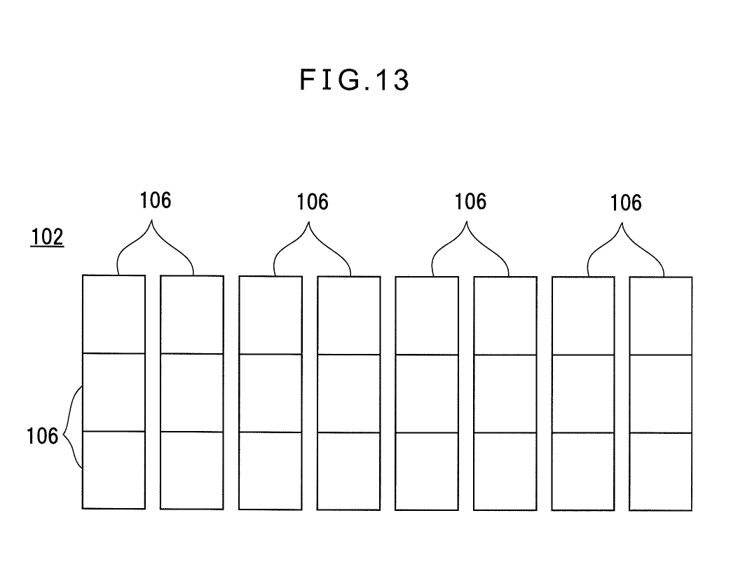

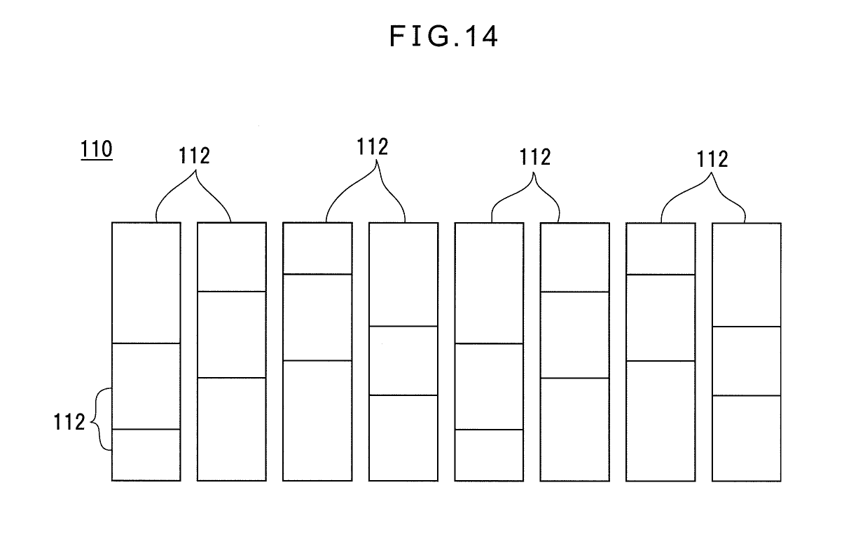

FIG. 11 is a schematic view showing magnet arrays 80 of a rotor of a rotational electric motor according to another embodiment of the present invention, in a developed plan view. Similarly to FIG. 10, the intermediate portion of the magnet arrays 80 is also omitted in FIG. 11. In this embodiment, a pair of adjoining magnet arrays 80 are arranged based on the same sequential pattern, and another pair of magnet arrays 80 adjacent thereto are arranged based on a sequential pattern different therefrom. Accordingly, for example, if a pair of magnet arrays 80 are arranged based on the above-described fifth sequential pattern, each pair of the magnet arrays 80 arranged adjacent thereto on both sides are arranged based on the sixth sequential pattern.

In this embodiment, the boundary planes between the magnets 16 of each magnet array 80 are offset relative to one another so as not to coincide with one another in the rotational direction of the rotor orthogonal to the laminating direction D. The number of the first magnet 16a having the smaller size in use is the same as the number of the magnet arrays 80. Therefore, in this embodiment, a rotational electric motor and a rotor used therefor with the advantages as described in relation to the above embodiment can be provided.

Although the embodiments in which one pole is formed by two magnet arrays are described by way of example, the pole may also be formed from three or more magnet arrays. The present invention is not limited to the laminated core integrally formed by adhesion or calking as described above, but can also be preferably applied to any laminated core in general.

How the magnets are arranged is not limited to the exemplary embodiments as illustrated. Although the symmetric arrangement pattern in the rotational direction as shown in the drawings may be desirable when quality of the rotor is taken into consideration, this is not necessarily required. With reference to the drawings, the embodiments in which the length of the magnet arrays in the laminating direction of the core is four, five or six times more than the length of the first magnet have been described above. However, the present invention can also be applied to magnet arrays having the larger size, i.e., seven times or longer than as the length of the first magnet.

### Effect of the Invention

In accordance with the first invention, the laminated core of the rotor can be prevented from being damaged. Also, since the rotor elongated in the laminating direction can be formed by using only two kinds of magnets, management cost and procurement cost of magnets can be reduced.

In accordance with the second invention, the number of the first magnets having the smaller size in the laminating direction can be restricted. In other words, as many as possible of the second magnets having the larger size are used. Accordingly, the number of the magnets in use can be decreased in total, so that productivity in attaching the magnets to the core can be improved. As a result, manufacturing cost of the rotor can be reduced.

In accordance with the third invention, in a rotor elongated in the laminating direction of the core, magnet arrays can be formed efficiently.

In accordance with the fourth invention, a rotational electric motor having the advantages as described in relation to the first to three inventions.

Although the invention has been shown and described with exemplary embodiments thereof, it should be understood by those skilled in the art that the foregoing and various other changes, omissions and additions may be made therein and thereto without departing from the spirit and scope of the invention.

What is claimed is:

1. A rotor of a rotational electric motor comprising:
a core formed from laminated magnetic steel sheets, and
a plurality of magnet arrays attached to the core and extending in a laminating direction of the core, wherein
each of the plurality of magnet arrays comprises a plurality of magnets arranged side by side in the laminating direction, the magnets comprising at least one of two kinds of magnets including a first magnet and a second magnet, a ratio of length of the first magnet to length of the second magnet in the laminating direction being one to two, at least two of the plurality of magnet arrays comprising at least two of the second magnets, and wherein
boundary planes between the magnets of each of the plurality of magnet arrays are offset relative to each other so as not to coincide with each other across a cross section of the core perpendicular to the laminating direction.

2. The rotor of a rotational electric motor according to claim 1, wherein the number of the first magnets used to form the plurality of magnet arrays is the same as the number of the magnet arrays.

3. The rotor of a rotational electric motor according to claim 1, wherein the core is configured in a laminating manner such that the length of the core in the laminating direction is an integer multiple of the length of the first magnet in the laminating direction and four times or more longer than the length of the first magnet in the laminating direction.

4. A rotational electric motor comprising the rotor according to claim 1.
